(19) United States
(12) Patent Application Publication
(10) Pub. No.: US 2025/0378693 A1
(43) Pub. Date: Dec. 11, 2025

(54) OBJECT MATCHING ON PARALLEL PROCESSING SYSTEMS

(71) Applicant: NVIDIA Corporation, Santa Clara, CA (US)

(72) Inventor: Daniël Gershon ABEL, Shanghai (CN)

(73) Assignee: NVIDIA Corporation, Santa Clara, CA (US)

(21) Appl. No.: 18/897,396

(22) Filed: Sep. 26, 2024

(30) Foreign Application Priority Data
Jun. 7, 2024 (WO) PCT/CN2024/098254

(51) Int. Cl. G06V 20/58; G06F 16/901; G06F 17/16

(52) U.S. Cl. CPC G06V 20/58; G06F 16/9024; G06F 17/16

(57) ABSTRACT

In various examples, systems and methods are disclosed relating to detecting objects on parallel processing systems. The systems can generate a graph of a cost matrix associating a plurality of first object elements with a plurality of second object elements. The graph can include a plurality of first nodes representing rows of the cost matrix and a plurality of second nodes representing columns of the cost matrix. The systems can determine a matching between the plurality of first nodes and the plurality of second nodes based at least on the cost matrix. The systems can then update the matching by generating an alternating tree and performing one or more matrix multiplications to update the matching based on the alternating tree detecting an unmatched second node of the graph.

### CROSS-REFERENCE TO RELATED APPLICATIONS

The present application claims the benefit of and priority to International Application No. PCT/CN2024/098254, filed Jun. 7, 2024, the disclosure of which is incorporated herein by reference in its entirety.

### BACKGROUND

Matching algorithms can be useful in tasks such as object detection and autonomous vehicle operations. For example, performing matching can be useful to assign relationships between sets of data, such as bounding boxes associated with detected objects. However, matching algorithms can be computationally expensive to execute and/or challenging to deploy.

### SUMMARY

Implementations of the present disclosure relate to object matching on parallel processing systems. In contrast to conventional systems, such as those described above systems and methods in accordance with the present disclosure can allow for improving efficiency of object matching via parallel processing systems. For example, instead of relying on global memory to process the object matching, systems and methods in accordance with the present disclosure can process the object matching on a single parallel processing unit.

At least one aspect relates to one or more processors. The one or more processors include one or more circuits to generate a graph of a cost matrix associating a plurality of first object elements with a plurality of second object elements. The graph can include a plurality of first nodes representing rows of the cost matrix and a plurality of second nodes representing columns of the cost matrix. The one or more circuits can determine a matching between the plurality of first nodes and the plurality of second nodes based at least on the cost matrix. The one or more circuits can update the matching by generating, based at least on the matching, an alternating tree that represents a path from a given second node along one or more edges connected with the given second node, and performing one or more matrix multiplications based at least on the alternating tree to detect an unmatched second node of the graph for which to update the matching. The one or more circuits can perform, using the updated matching, one or more object perception operations for at least a subset of object elements form one or more of the plurality of first object elements or the plurality of second object elements.

In some implementations, the one or more circuits determine the matching by identifying, by each first node and using a respective processing thread of a plurality of processing threads, a second node of the plurality of second nodes with which the first node is connected, and by selecting, by each second node, the first node that identified the second node. The one or more circuits can generate a first bit array to represent the alternating tree. The one or more circuits can perform the one or more matrix multiplications, using a plurality of processing threads, as one or more bitwise matrix multiplications of a matrix including the first bit array and a plurality of second bit arrays.

In some implementations, the plurality of first object elements include estimated bounding boxes generated by an object detector, the plurality of second object elements include reference bounding boxes, and the one more circuits update the object detector based at least on the updated matching. The plurality of first object elements can correspond to data from a sensor of a vehicle (or simulated sensor for a simulated vehicle). The one or more circuits can update the matching by adding a match between the unmatched second node and a first node corresponding to the unmatched second node.

The one or more circuits can determine the matching based on identifying respective matches between the plurality of first nodes and plurality of second nodes that satisfy a feasibility criterion.

At least one aspect relates to a system. The system can include one or more processing units and one or more memory units storing instructions that, when executed by the one or more processing units, cause the one or more processing units to execute operations that include, without limitation, generating a graph of a cost matrix associating a plurality of first object elements with a plurality of second object elements, the graph including a plurality of first nodes representing rows of the cost matrix and a plurality of second nodes representing columns of the cost matrix. The operations can include determining a matching between the plurality of first nodes and the plurality of second nodes based at least on the cost matrix. The operations can include updating the matching by generating, based at least on the matching, an alternating tree that represents a path from a given second node along one or more edges connected with the given second node, and performing one or more matrix multiplications based at least on the alternating tree to detect an unmatched second node of the graph for which to update the matching. The operations can include performing, using the updated matching, one or more object perception operations for at least a subset of object elements form one or more of the plurality of first object elements or the plurality of second object elements.

In some implementations, the one or more processing units determine the matching by identifying, by each first node and using a respective processing thread of a plurality of processing threads, a second node of the plurality of second nodes with which the first node is connected, and selecting, by each second node, the first node that identified the second node. The one or more processing units can generate a first bit array to represent the alternating tree. The one or more processing units can perform the one or more matrix multiplications, using a plurality of processing threads, as one or more bitwise matrix multiplication operations of a matrix comprising the first bit array and a plurality of second bit arrays.

In some implementations, the plurality of first object elements include estimated bounding boxes generated by an object detector, the plurality of second object elements include reference bounding boxes. The one or more processing units can update the object detector based at least on the updated matching. The plurality of first object elements can correspond to data from a sensor of a vehicle.

At least one aspect relates to a method. The method can include generating a graph of a cost matrix associating a plurality of first object elements with a plurality of second object elements, the graph including a plurality of first nodes representing rows of the cost matrix and a plurality of second nodes representing columns of the cost matrix. The method can include determining a matching between the plurality of first nodes and the plurality of second nodes based at least on the cost matrix. The method can include updating the matching by generating, based at least on the matching, an alternating tree that represents a path from a given second node along one or more edges connected with the given second node, and performing one or more matrix multiplications based at least on the alternating tree to detect an unmatched second node of the graph for which to update the matching. The method can include performing, using the updated matching, one or more object perception operations for at least a subset of object elements form one or more of the plurality of first object elements or the plurality of second object elements.

In some implementations, the method includes identifying, by each first node and using a respective processing thread of a plurality of processing threads, a second node of the plurality of second nodes with which the first node is connected. The method can include selecting, by each second node, the first node that identified the second node. The method can include generating a first bit array to represent the alternating tree. The method can include performing the one or more matrix multiplications, using a plurality of processing threads, as one or more bitwise matrix multiplications of a matrix comprising the first bit array and a plurality of second bit arrays.

In some implementations, the plurality of first object elements include estimated bounding boxes generated by an object detector, the plurality of second object elements include reference bounding boxes, and the method includes updating the object detector based at least on the updated matching. The plurality of first object elements can correspond to data from a sensor of a vehicle. The method can include updating, by the one or more processors, the matching by adding a match between the unmatched second node and a first node corresponding to the unmatched second node to the matching.

The processors, systems, and/or methods described herein can be implemented by or included in at least one of a system for generating synthetic data; a system for performing simulation operations; a system for performing conversational AI operations; a system for performing collaborative content creation for 3D assets; a system that includes one or more language models, such as large language models (LLMs); one or more vision language models (VLMs); a system for generating or presenting virtual reality (VR) content, augmented reality (AR) content, and/or mixed reality (MR) content; a system for performing digital twin operations; a system for performing light transport simulation; a system for performing deep learning operations; a system implemented using an edge device; a system implemented using a robot; a system associated with an autonomous or semi-autonomous machine (e.g., an in-vehicle infotainment system); a system incorporating one or more virtual machines (VMs); a system implemented at least partially in a data center; or a system implemented at least partially using cloud computing resources.

### BRIEF DESCRIPTION OF THE DRAWINGS

The present systems and methods for object matching on parallel processing systems are described in detail below with reference to the attached drawing figures, wherein:

FIG. 1 is a block diagram of an example parallel processing matching system, in accordance with some implementations of the present disclosure;

FIG. 2 is an example equality graph that can be used to represent a cost matrix, in accordance with some implementations of the present disclosure;

FIG. 3 is another example equality graph with matching that can be used to represent a cost matrix, in accordance with some implementations of the present disclosure;

FIG. 4 is a diagram of alternating tree initialization and bitwise matrix multiplication of an example alternating tree algorithm, in accordance with some implementations of the present disclosure;

FIG. 5 is an example equation of bitwise matrix multiplication, in accordance with some implementations of the present disclosure;

FIG. 6 is a flow diagram of a method for object detection on parallel processing systems, in accordance with some implementations of the present disclosure;

FIG. 7 is an illustration of an example autonomous vehicle, in accordance with some implementations of the present disclosure;

FIG. 8 is an example of camera locations and fields of view for the example autonomous vehicle of FIG. 7, in accordance with some implementations of the present disclosure;

FIG. 9 is a block diagram of an example system architecture for the example autonomous vehicle of FIG. 7, in accordance with some implementations of the present disclosure;

FIG. 10 is a system diagram for communication between cloud-based server(s) and the example autonomous vehicle of FIG. 7, in accordance with some implementations of the present disclosure;

FIG. 11 is a block diagram of an example computing device suitable for use in implementing some implementations of the present disclosure; and

FIG. 12 is a block diagram of an example data center suitable for use in implementing some implementations of the present disclosure.

### DETAILED DESCRIPTION

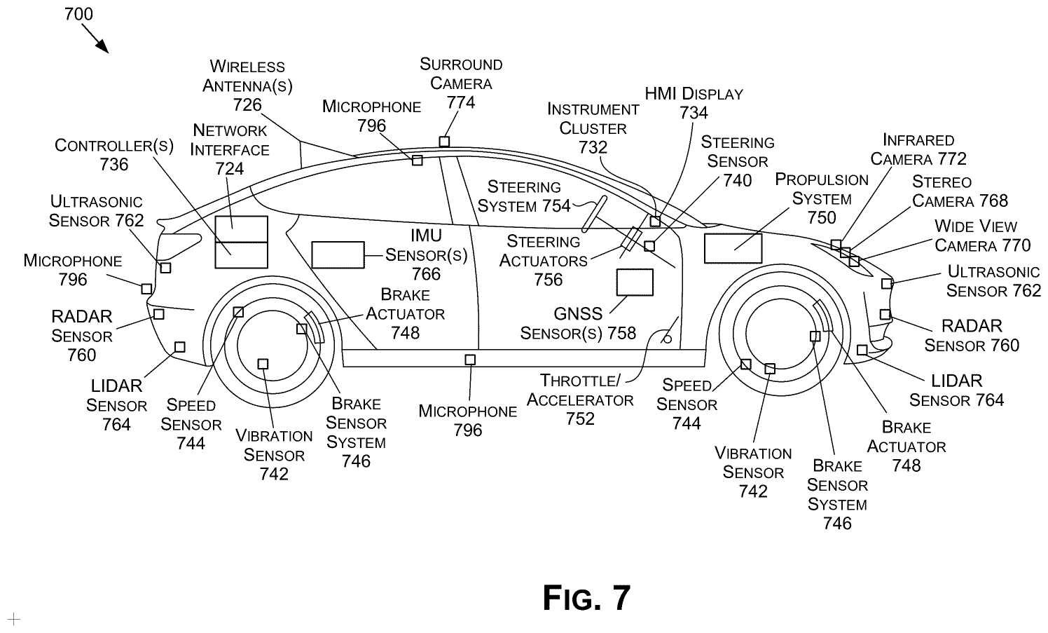

Systems and methods are disclosed related to object matching on parallel processing systems. Although the present disclosure may be described with respect to an example autonomous vehicle 700 (alternatively referred to herein as “vehicle 700” or “ego-vehicle 700,” an example of which is described with respect to FIGS. 7-10), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to matching operations for autonomous vehicle operations, this is not intended to be limiting, and the systems and methods described herein may be used in augmented reality, virtual reality, mixed reality, robotics, security and surveillance, autonomous or semi-autonomous machine applications, and/or any other technology spaces where matching operations may be used.

This disclosure relates to systems and methods for object matching on parallel computing systems, such as to deploy a parallel adaptation of graph-based matching algorithms, including, for example, combinatorial optimization algorithms such as the Hungarian algorithm (also known as the Kuhn-Munkres algorithm or Munkres assignment algorithm) and/or bipartite graph algorithms, using parallel computing systems, streaming multiprocessors, and/or graphics processing units (GPUs).

Matching operations can be useful in tasks such as object detection and autonomous vehicle operations. For example, performing matching can be useful to assign relationships between sets of data, such as bounding boxes associated with detected objects. As an example, matching operations can match test bounding boxes (e.g., generated by an object detector) with reference bounding boxes, such as for training the object detector. For example, a matrix representing a cost (or loss) function applied to all pairs of reference and test objects in machine learning training can be processed to generate a high performance, e.g., optimal, matching between the reference and test objects. This can correspond to finding a permutation of rows of the matrix that minimizes or maximizes a trace of the matrix (e.g., sum of diagonal elements). The cost function can define costs associated with pairs of elements (e.g., reference and test elements), such as distance costs.

The Hungarian algorithm, for example, can be used to perform such matching operations; the Hungarian algorithm can include steps such as initialization, generation and/or compression of an equality graph, initial matching, alternating tree generation, augmentation of paths, and labeling to enlarge the quality graph. The alternating tree generation, augmentation, and labeling operations can be iteratively performed until all matches are found.

However, matching algorithms can be computationally expensive to execute and/or challenging to deploy using a parallel processing system. For example, the Hungarian algorithm can be analogous to a (sequential) path finding algorithm, and thus not suitable for parallelization as typically performed.

Systems and methods in accordance with the present disclosure can allow for matching operations, such as matching techniques that incorporate at least some (or all) aspects of the Hungarian algorithm, to be performed more effectively, such as to be deployed using parallel processing systems.

A graph, e.g., equality graph, can be determined in which a plurality of first nodes (e.g., “x-nodes”) represent rows of the matrix, and a plurality of second nodes (e.g., “y-nodes”) represent columns of the matrix. An initial matching for the graph can be performed by (1) causing each first node to identify a candidate second node to match with and (2) causing each second node to select a corresponding first node that the second node is connected with and for which the second node has been identified as a candidate second node. Various aspects of the initial matching can be made parallel. For example, the identification of candidate second nodes by the first nodes can be stored in memory that is shared across threads (e.g., processing threads used for the first nodes to identify candidate second nodes). These operations can be repeated, e.g., until no more nodes can be matched in this way.

To improve the matching from the graph (and thus the underlying matches represented by the cost matrix), alternating trees can be defined based on identifying paths between nodes in the graph that are connected by edges. Unmatched nodes can be detected by forming a matrix of bit arrays that represent the alternating trees, and performing a bitwise matrix-matrix multiplication of the matrix with itself. The system can use the detected unmatched nodes to augment the matching. The bitwise matrix multiplication can be parallelized, e.g., by assigning each bit array to a respective thread (e.g., of a streaming multiprocessor), which can make the computation more efficient. The output of the system can represent a modification to the cost matrix corresponding to an optimized matching of the data used to form the cost matrix.

As a result, evaluation of data structures, such as a cost matrix representative of detecting matches between data elements (e.g., cost matrix) can be solved on a single streaming multiprocessor (SM) and/or a parallel processing unit. This avoids a usage of redundant global memory (e.g., DRAM and/or HBM memory) accesses or latencies as well as synchronization. The single problem can be loaded into a shared memory of the SM (e.g., a L1 cache) and the problem can be solved entirely using the shared memory and registers of the SM. This can allow the higher bandwidth of components such as the L1 cache and registers to be utilized to allow for more efficient operations than where global memory may be used.

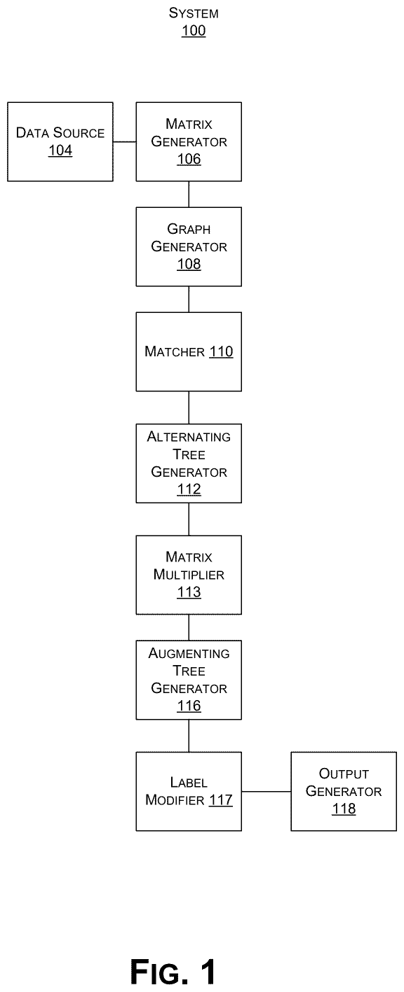

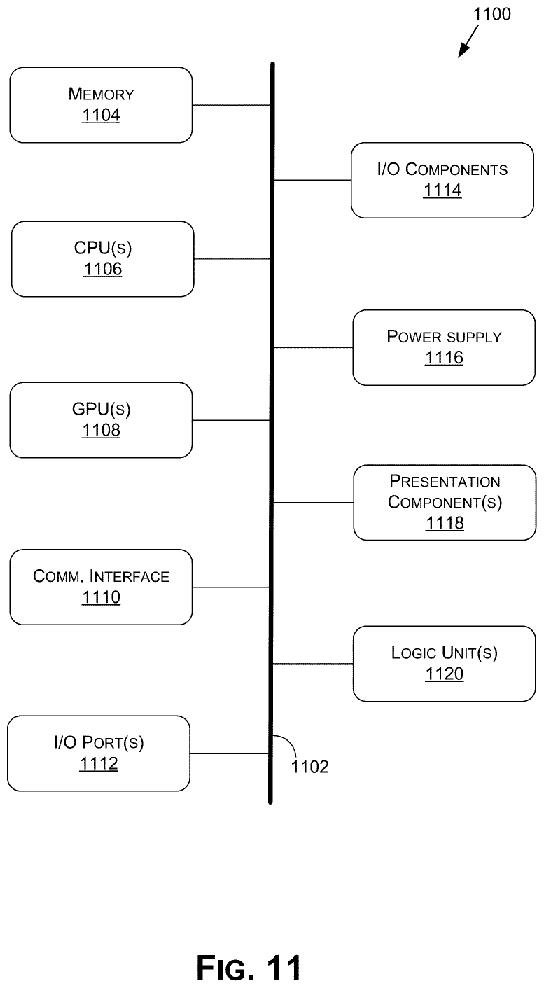

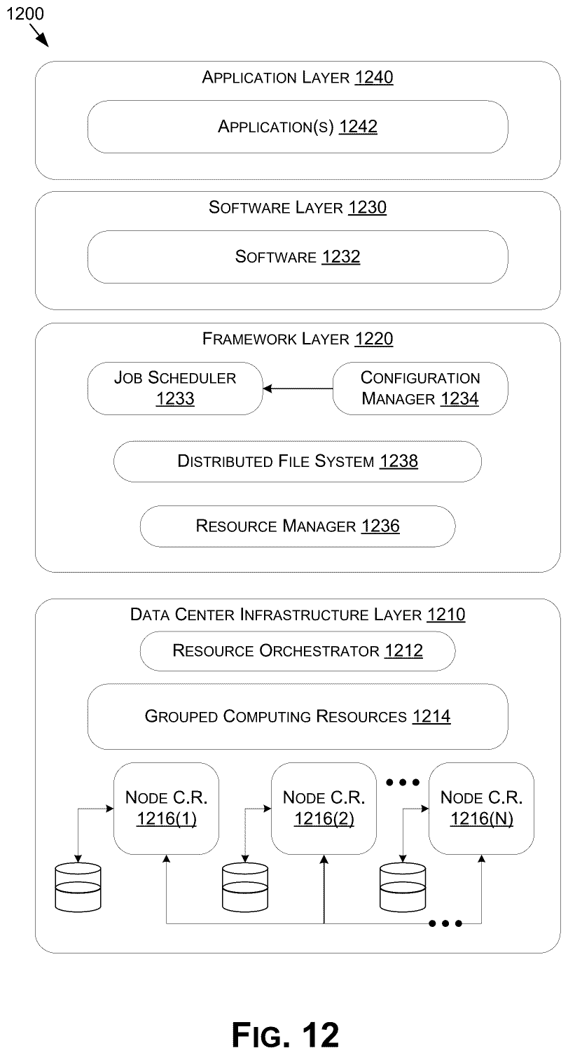

With reference to FIG. 1, FIG. 1 is an example system 100, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some implementations, the systems, methods, and processes described herein may be executed using similar components, features, and/or functionality to those of example autonomous vehicle 700 of FIGS. 7-10, example computing device 1100 of FIG. 11, and/or example data center 1200 of FIG. 12.

Various functions described with reference to the components of the system 100 described further herein can be performed in various orders and/or combined or moved to other components of the system 100.

The system 100 can include or be coupled with one or more data sources 104. The data sources 104 can include any of various databases, data sets, or data repositories, for example and without limitation. The one or more data sources 104 can be maintained by one or more entities, which may be entities that maintain the system 100 or may be separate from entities that maintain the system 100. The data source 104 can provide data that the system 100 can receive as and/or represent as one or more cost matrices or one or more graphs, for example and without limitation. The data source 104 can include data from any suitable image dataset including labeled and/or unlabeled image data. In some examples, the data sources 104 include data from large-scale image datasets (e.g., ImageNet) that are available from various sources and services. The data source 104 can include data associated with a machine learning pipeline, such as a cost matrix associated with object detection and/or detecting matches (e.g., by a vision model, computer vision system, and/or machine learning model) or object tracking. In some implementations, the system 100 uses a cost matrix for a maximization or minimization (e.g., by performing a subtraction on the cost matrix to convert a maximization into a minimization, or vice versa).

The data sources 104 can include, without limitation, data such as any one or more of text, speech, audio, image, and/or video data. The system 100 can perform various pre-processing operations on the data, such as filtering, normalizing, compression, decompression, upscaling or downscaling, cropping, and/or conversion to grayscale (e.g., from image and/or video data). Images (including video) of the data source 104 can correspond to one or more views of a scene captured by an image capture device (e.g., camera), or images generated computationally, such as simulated or virtual images or video (including by being modifications of images from an image capture device).

In some implementations, the data source 104 includes image data and/or video data from a camera and/or sensor coupled to the autonomous vehicle 700. The data source 104 can continuously receive and store image data and/or video data from the camera. For example, as the autonomous vehicle 700 is moving, the data source 104 can continually store new image data and/or video data that the camera of the autonomous vehicle 700 captures. Within the image data and/or video data, the data source 104 can also include bounding boxes. The bounding boxes can correspond to detected objects and represent a boundary of the detected object within the image data and/or video data. Bounding boxes can be generated around a potential object in an image and/or video. The bounding boxes can include generated test (e.g., estimated, actual) bounding boxes and reference bounding boxes. The data source 104 can be continually updated based on detected objects within the image and/or video data and a subsequent processing of the detected objects.

In one or more implementations, the system includes one or more matrix generators 106. The matrix generator 106 can receive image data and/or video data including a plurality of bounding boxes from the data source 104. The plurality of bounding boxes can correspond to a plurality of objects within a frame of the image data and/or video data. The matrix generator 106 can generate a matrix (e.g., cost matrix) for each of the plurality of bounding boxes. The matrix can be a bit matrix. For example, the matrix generated by the matrix generator 106 can associate a plurality of first object elements with a plurality of second object elements.

In some implementations, the first object elements are test bounding boxes (e.g., potential objects) and the second object elements are reference bounding boxes (e.g., known objects). The matrix can then be defined by assigning a cost (e.g., weight) indicating a score of a match between each test bounding box and a corresponding reference bounding box. The cost matrix can represent a similarity between objects of the test bounding boxes and the reference bounding boxes. The matrix generator 106 can define costs for comparisons between the test bounding boxes and the reference bounding boxes to determine values to include the matrix. For example, the cost can include at least one of a distance cost or a color cost.

For example, the matrix generator 106 can receive the test bounding box as an input, and convert data of the test bounding box to the matrix by comparing the test bounding box to reference bounding boxes stored in the data source 104. The data of the bounding box can include, without limitation to, color information, pixel data, frame speed, distance from camera and/or sensor, etc. The bounding box corresponding to a vehicle, for instance, can be transformed into a representative bit matrix of the cost (e.g., difference) with the vehicle and other objects within reference bounding boxes.

The matrix generator 106 can minimize the cost matrix by maximizing the cost matrix and subtracting the maximized cost matrix with an initial cost matrix (e.g., matrix generated from the reference and test bounding boxes by the matrix generator 106). This can allow the system 100 to more flexibly handle various operations.

In some implementations, the system includes one or more graph generators 108. The graph generator 108 can receive the matrix from the matrix generator 106 and input rows and columns of the matrix into a graph (e.g., equality, bipartite graph). The equality graph can include a plurality of first nodes representing rows of the matrix and a plurality of second nodes representing columns of the matrix. The graph generator 108 can generate a graph for each of a plurality of matrices from the matrix generator 106. The equality graph can include a plurality of edges (e.g., elements of the matrix) determined by initial labeling of the matrix, such as where the system 100 determines an initial labeling that satisfies a feasibility criterion. For example, the system 100 can determine the labeling based on determining a max of each row of the matrix and a max of each column of the matrix minus a labeling lₓ(x). In this case, edge (x, y) of the matrix can be part of the equality graph responsive to the system 100 determining lₓ(x)+l_{y}(y)=w(x,y). The labeling of the graph can be updated and/or changed while satisfying lₓ(x)+l_{y}(y)≥w(x,y) to be feasible.

In some implementations, the system includes one or more components to manage initial matching (e.g., node to node proposals and acceptances), represented in FIG. 1 as matchers 110. The matcher 110 can receive the graph from the graph generator 108 and can determine an initial matching between the plurality of first nodes and the plurality of second nodes based on at least the cost matrix. For example, the matcher 110 can cause each of the plurality of first nodes, responsive to being unmatched, to propose matching to a candidate second node of the plurality of second nodes to match with. The second node, responsive to being unmatched, can then select a corresponding first node that the second node is connected with and propose to be matched to it. The second node can match with a first node of the plurality of first nodes that the second node finds. For example, one or more first nodes may propose to an unmatched second node and the second node will propose and be matched to the first node of the plurality of first nodes it finds. For example, each of the plurality of first nodes can identify a second node of the plurality of second nodes with which the first node is connected. Each second node can then select the first node of the plurality of first nodes that identified the second node.

The matcher 110 can perform the matching process using parallel operations. For example, matching of each of the plurality of first nodes can be conducted simultaneously on a plurality of processing threads (e.g., parallel threads, threads). Identification of unmatched, candidate second nodes can be stored in memory that is shared across the plurality of processing threads to ensure multiple matchings of the second node to a first node does not occur. The plurality of processing threads can be included in a thread block (e.g., warp) and launched (e.g., processed) by a streaming multiprocessor (SM). The plurality of first nodes can be processed and correspond to the plurality of processing threads and be processed in parallel by the SM.

The system 100 can map nodes to respective processing threads. For example, each of the plurality of processing threads can correspond to each of the plurality of first nodes or the plurality of second nodes. For example, the first node can identify the second node of the plurality of second nodes with which the first node is connected using a respective processing thread of the plurality of processing threads.

In one or more implementations, the system 100 includes one or more alternating tree generators 112. The alternating tree generator 112 can initialize an alternating tree for each of the plurality of first nodes or second nodes where at least (e.g., each) alternating tree is represented by a bit array with a size based on the number of first or second nodes. The alternating tree can include a plurality of alternating paths that can originate from the first node or the second node. Alternating paths can be a path including a sequence of connected edges in the graph where out of every two consecutive connected edges, one is connected to a matched first or second node. The alternating tree can represent a path from the second node along one or more edges connected with the second node. The alternating tree can be further defined based on identifying paths between nodes in the graph that are connected by edges.

The bit array of the alternating tree for each of the plurality of second nodes can be determined by a number of connections with the plurality of first nodes where the connection is represented by 1 and a lack of the connection is represented by 0. For example, if the second node is unmatched, its own bit is set to 1 while others are set to 0. Bit arrays of a plurality of alternating trees can be input into a tree bit matrix with rows or columns of the tree bit matrix being the bit array of each of the plurality of alternating trees. The tree bit matrix can be stored in a register (e.g., of the SM) where each thread of the SM holds each bit array of the plurality of alternating trees. For example, each of the plurality of processing threads of the SM can correspond to each row of the tree bit matrix.

In at least one implementation, the system 100 includes one or more matrix multipliers 113. Responsive to the tree bit matrix being created by the alternating tree generator 112, the matrix multiplier 113 can perform bitwise matrix multiplication of the tree bit matrix (e.g., perform one or more bitwise matrix multiplications, such as to transpose one or more portions of the tree bit matrix to facilitate the bitwise matrix multiplications). In some implementations, the tree bit matrix provided by the alternating tree generator 112 can be a plurality of second nodes tree bit matrix (e.g., the bit matrix only includes trees of the second nodes). The tree bit matrix can be truncated following bitwise matrix multiplication (e.g., to generate an output having ones or zeros at each respective element of the matrix, such as a one for a non-zero number at the respective element). The matrix multiplier 113 can take each row and column pair of the tree bit matrix and perform a bitwise inner product. The tree bit matrix can be multiplied by itself (e.g., iteratively until no further changes occur to the result of the matrix multiplication) to determine which of the plurality of first nodes and the plurality of second nodes are unmatched. For example, if a column of the tree bit matrix represents the alternating tree of one of the plurality of first nodes and one of the values of the column is 0, this can indicate that one of the plurality of second nodes is unmatched. The bitwise matrix multiplication can be performed based on at least the alternating tree to detect an unmatched second node of the graph to update a state of the matching of the graph. The bitwise matrix multiplication can be performed with bitwise OR (e.g., |) and bitwise AND (e.g., &) operations which can increase a speed of the bitwise matrix multiplication process. As an example, where the bit matrix data structure is configured such that each row of the tree bit matrix has 4 integers each with 32 bits, the matrix multiplier 113 can achieve a performance improvement of 32 times fewer operation. By using bitwise OR and bitwise AND operations, an entire inner product of the tree bit matrix is not computed but rather focused on if the inner product (e.g., elements of the tree bit matrix) is zero or larger than zero to more efficiently perform the bitwise matrix multiplication. For examples, elements that overlap (e.g., diagonal elements of the tree bit matrix) can be skipped with performing bitwise matrix multiplication. For example, because the tree bit matrix represents values in bits (and/or in ones and zeros), which the matrix multiplier 113 subsequently truncates, any matrix multiplication operation of a row and column can have a result of one as long as a corresponding row element and column element of the row and column are each one, such that the bitwise operation(s) can be used to perform such comparisons, obviating the added computations of an inner product (e.g., where a row of the tree bit matrix is [1, 1, 0] and a column is [0, 1, 1], the bitwise comparison between the second elements of the row and column can be used to determine that the result of the multiplication will be 1, and thus a full inner product need not be determined).

Bitwise matrix multiplication by the matrix multiplier 113 can be repeated until no change occurs in the tree bit matrix and every cycle of bitwise matrix multiplication can be followed by truncating the tree bit matrix. The bitwise matrix multiplication can also be repeated until 2 log N (e.g., N is equal to a size of the tree bit matrix) steps (e.g., cycles) have occurred. In some implementations, following bitwise matrix multiplication by the matrix multiplier 113, there remains no unmatched second nodes in the plurality of second nodes.

At least one implementation of the system includes one or more augmenting tree generators 116. The augmenting tree generator 116 can evaluate the tree bit matrix following multiplication by the matrix multiplier 113, such as to detect unmatched nodes and/or perform augmentation of the matching based on matches detected for unmatched nodes. The augmenting tree generator 116 can determine, by the multiplied tree bit matrix, if there are remaining unmatched nodes within the plurality of first nodes and the plurality of second nodes. For example, the augmenting tree generator 116 can determine that all the plurality of first nodes and the plurality of second nodes are matched and perfect matching has been achieved within the graph. All of the nodes being matched can indicate that the system 100 has determined an optimized cost matrix (e.g., accurate in determining what the detected object is). For example, perfect matching of the graph would occur when each of the plurality of first nodes and the plurality of second nodes is matched at most once, and all of the plurality of first nodes and second nodes are matched. A 1 within the tree bit matrix can indicate that the second node corresponding to the 1 value is connected to the second node also corresponding to the 1. For example, given a matrix A with size 3, if the value of A23=1, this would indicate that a connection (e.g., ends or passes through) exists between row 2 (e.g., y₂) and column 3 (e.g., y₃). In this case, the alternating trees of the second nodes relate connectivity between the alternating trees of the plurality of second nodes.

Responsive to the augmenting tree generator 116 determining that there are remaining unmatched nodes, the augmenting tree generator 116 can increase a number of matches within the graph. The augmenting tree generator 116 can generate an augmenting tree at an unmatched first or second node and generate augmenting paths via a path searching algorithm. The alternating tree can be an augmenting tree where at least one of the plurality of first nodes and at least one of the plurality of second nodes is unmatched. The alternating tree generator 112 creates alternating trees for unmatched first nodes which can allow for the augmenting tree generator 116 to build augmenting trees for unmatched second nodes. For example, the augmenting tree generator 116 can help determine, for each unmatched first node, whether it is connected to an unmatched second node and if so, can generate an augmented path for that connection. The augmenting path is an alternating path that starts at an unmatched first node and end with an unmatched second node. During augmentation, matches within the augmenting path are removed and other edges are added to increase the number of matches within the augmenting path.

The augmenting trees generated by the augmenting tree generator 116 can, by performing path augmentation, increase a number of matches within the equality graph. For example, path augmentation can increase a number of nodes that are matched with each augmenting path increasing the matching size by one.

In some implementations, the augmenting tree generator 116 can perform path augmentation, increasing the matches in the augmenting path in parallel (e.g., simultaneously). For example, the augmenting paths that are augmented in parallel are vertex disjunct (e.g., share no first or second nodes). Disjunction in the augmenting trees of the unmatched first or second nodes can be checked using the generated trees to ensure that the selection of augmenting paths to be augmented are vertex disjunct. In at least one implementation, this can be done efficiently by inspecting alternating trees of the second nodes using bitwise AND operations on two augmenting trees (e.g., tree represented by bit arrays and constructed by the augmenting tree generator 116) that connect with inspected second nodes.

The augmenting tree generator 116 can determine which augmenting paths will not interfere (e.g., augmenting paths with no first nodes or second nodes in common). Responsive to the alternating trees (e.g., the bit arrays) associated with the unmatched first or second nodes having no first or second nodes in common, the augmenting tree generator 116 can perform path augmentation in parallel (e.g., as described further herein).

In some implementations, the tree bit matrix provided by the augmenting tree generator 116 can be a plurality of first nodes tree bit matrix (e.g., the tree bit matrix only includes trees from first nodes). Responsive to performing path augmentation, the augmenting tree generator 116 can determine whether the equality graph has achieved a target criterion of the system 100 (e.g., sufficient connectivity to allow for augmentation and increase matching in the equality graph). Responsive to evaluating that there are remaining unmatched first or second nodes in the augmenting tree, the augmenting tree generator 116 can cause the augmenting tree generator 116 to continue performing path augmentation. The augmenting trees can be created from a union of alternating trees of the plurality of second nodes in which unmatched first nodes are connected to in the equality graph.

At least one implementation of the system 100 includes one or more label modifiers 117. Following augmentation by the augmenting tree generator 116, the label modifier 117 can modify the labels of the plurality of first nodes and the plurality of second nodes based on the path augmentation (e.g., path changes). To improve (e.g., update) matching within the equality graph after no more augmentations can take place, the labeling of the graph can be improved via the label modifier 117 which increases the connectivity between unmatched first nodes with eventually at least one unmatched second node. The label modifier 117 can add additional edges and subtract edges from the equality based on matches made by path augmentation. Thus, to improve matching within the equality graph, after no more augmentations can take place, the labeling of the graph can be improved by increased the connectivity between unmatched first nodes with eventually at least one unmatched second node. The label modifier 117 can add edges to the equality graph, such as to (eventually) connect one or more x-nodes within the alternating tree starting at one or more unmatched x-nodes, to at least one unmatched y-node. This can guarantee that augmentation will be possible through path augmentation after this has been the operation of the label model 117 has been depleted. The x-nodes involved in each such tree can be retrieved by the y-node bit array representation of the tree determined by the augmenting tree generator 116. Obtaining these nodes can be done in O(1) time on a parallel implementation.

At least one implementation of the system 100 includes one or more output generators 118. Responsive to determining that all of the plurality of first nodes and second nodes are matched, the label modifier 117 can provide the updated graph to the output generator 118. In some implementations, the output generator 118 outputs the updated graph. In some implementations, the output generator 118 can indicate what object was and/or is detected by the object detector. For example, the output generator 118 can indicate that that the test bounding box has been matched to the reference bounding box that minimizes a sum of costs which indicates an overall best fit. Results of the output generator 118 can update the data source 104 to include additional reference bounding boxes.

In at least one implementation, the output generator 118 can perform, using the updated matching and graph of the label modifier 117, one or more object perception operations (e.g., identifying the object) for at least a subset of object elements from one or more of the plurality of first object elements or the plurality of second object elements. For example, the output generator 118 can determine an identity of the object for the subset of object elements. The output of the output generator 118 can include a data structure to represent the updated graph and/or the identity of the object. For example, the data structure can be in various forms such as, without limitation, a string, bit array, characters, a dataset, a database, size information, and color information.

For example, the output generator 118 can include or be coupled with at least one machine learning model. The machine learning model can include one or more object detectors, object trackers, and/or computer vision processors. The output generator 118 can use the updated matching to update a cost matrix associated with output of the at least one machine learning model, such as for training the machine learning model. For example, the output generator 118 can retrieve or generate the cost matrix based on estimated object data (e.g., test bounding boxes and/or classification labels) generated by the machine learning model and corresponding reference object data (e.g., reference bounding boxes and/or classification labels), can generate an initial matching of a graph based on the cost matrix, can update the initial matching by determining alternating trees and/or augmenting trees from the initial matching, can improve labeling of the graph based on the updating of the initial matching, and can use the improved labeling to update the machine learning model.

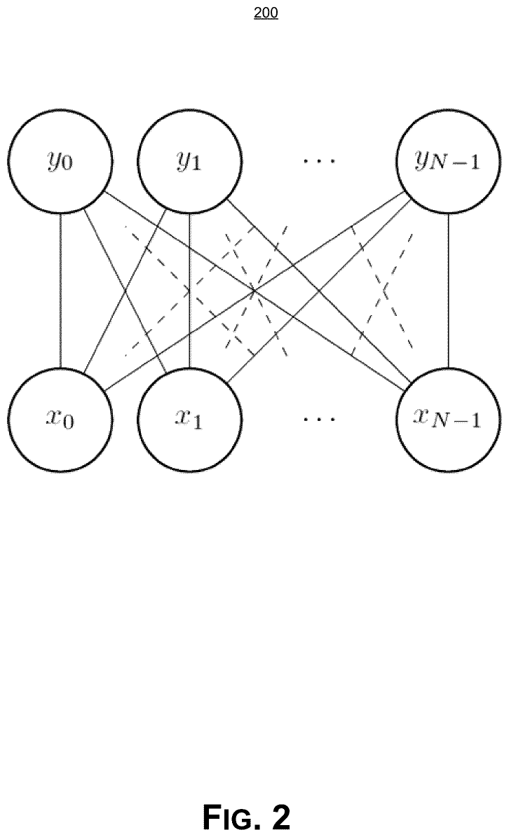

Now referring to FIG. 2, FIG. 2 depicts an example input matrix graph 200 that can be used to represent a matrix, in accordance with some implementations of the present disclosure. An equality graph can be a subset of the input matrix graph 200. For example, the input matrix graph 200 can be generated by the graph generator 108. The input matrix graph 200 can be derived from a cost function or square weight matrix W of dimension N×N with elements wᵢⱼ. The goal is to find a permutation of the rows such that a trace of the matrix (e.g., sum of the diagonal elements of the matrix) is maximized by

$$P = \begin{matrix}max \\ {P}^{′}\end{matrix} {TRP}^{′} W \qquad ( 1 )$$

where Tr is the trace of the matrix.

Each y∈Y node, representing a column in the matrix, can be assigned a unique x∈X node, representing a row in the matrix through

$$match ( y ) : y ∈ Y ↦ x ∈ X with match ( {y}_{i} ) = match ( {y}_{j} ) ⇒ {y}_{i} = {y}_{j} . \qquad ( 2 )$$

An equivalent function of the problem stated in Equation 1 can find the function match(y) in Equation 2 that maximizes an accumulated weight by

$$\begin{matrix}max \\ match ( y )\end{matrix} {\sum }_{y} w ( match ( y ) , y ) \qquad ( 3 )$$

where the matrix elements are denoted wᵢⱼ=w(match(y),y). Equation 3 can allow for a transformation of the combinatorial problem in Equation 1 into a graph theoretical problem (e.g., a graph generated by the graph generator 108).

For example, input matrix graph 200 is a fully connected graph that can be used to represent the matrix W by assigning weights to each edge, w_{(x,y)}=w(x,y). The graph 200 (e.g., G=(V,E)) is called a bipartite graph such that the vertices can be split into two disjunct sets-X and Y with V=X∪Y such that all edges are incident upon one vertex of both sets.

The input matrix graph 200 can then be labeled. Labeling can be a real-valued function defined on all vertices V→ [symbol] . For graphs generated by the graph generator 108, the labeling can be split into two parts lₓ(x), l_{y}(y), with lₓ(x) which takes x∈X as an argument and l_{y}(y) which takes y∈Y as an argument. A labeling l is called feasible if lₓ(x)+l_{y}(y)≥w(x,y). A matching M is a subset of edges in a graph, or a subgraph, in which each node is adjacent to at most one edge in M. the matching M is called a perfect matching if all vertices (e.g., the plurality of first nodes and the plurality of second nodes) in the graph are matched.

For example, an edge of the graph is incident upon a vertex or node v if for that edge e=(x,y)v∈{x,y}. Similarly, the vertex is adjacent to a matching M if at least one edge is incident to it. The vertex is matched by a matching M if it is adjacent to M. The size of the matching is |M| or the number of edges contained in M.

Thus, if the labeling l is feasible and M is a perfect matching in Eₗ, then M is a maximum weight matching. If the labeling l is feasible, an upper limit of any perfect matching M′ can be derived that is not necessarily in Et as demonstrated by

$$w ( {M}^{′} ) = {\sum }_{e ∈ {M}^{′}} w ( e ) \leq {\sum }_{\{ x y \} ∈ {M}^{′}} ( l ( x ) + l ( y ) ) = {\sum }_{v ∈ V} l ( v ) . \qquad ( 4 )$$

The inequality in Equation 4 shows that the sum of all labels is an upper limit of the weight associated with the matching M′. If a matching for which the equality holds is found, then a max-weight matching is found since any other matching yields either the same weight or lower. Now let M be a perfect matching in the equality graph Eₗ, then

$$w ( {M}^{′} ) = {\sum }_{e ∈ M} w ( e ) = {\sum }_{v ∈ V} l ( v ) \qquad ( 5 )$$

So w(M′)≤w(M) for any other M′ and M is optimal.

The equality graph (e.g., the input matrix graph 200) is the subset of edges Et in the graph G for which the equality lₓ(x)+l_{y}(y)=w(x,y) holds as seen by

$${E}_{l} = \{ ( x , y ) \vert {l}_{x} ( x ) + {l}_{y} ( y ) = w ( x , y ) \} . \qquad ( 6 )$$

As described above, the Hungarian Algorithm aims to find a feasible labeling l and a perfect matching M with respect to that labeling that is contained in the equality graph Gₗ.

To improve the labeling as described above, alternating trees can indicate how to perform path augmentation.

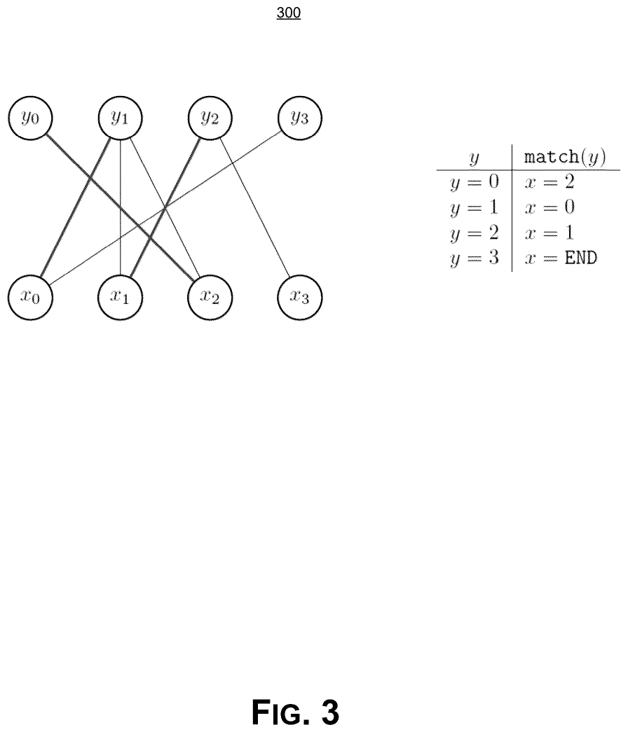

Now referring to FIG. 3, FIG. 3 depicts an example equality graph 300 with matching that can be used to represent a matrix, in accordance with some implementations of the present disclosure. The equality graph 300 can also be described as

$${E}_{l} = \{ ( 0 , 1 ) , ( 0 , 3 ) , ( 1 , 1 ) , ( 1 , 2 ) , ( 2 , 0 ) , ( 2 , 1 ) , ( 3 , 2 ) , \}$$

and matching M with unmatched nodes x₃ and y₃ as M={(0,1), (1,2), (2,0)}.

The alternating path can be defined relative to the matching M in the equality graph. A path including a sequence of connected edges in the equality graph {e∈Eₗ} is an alternating path if, out of every two consecutive connected edges within the path, exactly one is in the matching M. No edges or vertices appear more than once in the path.

There can be two kinds of alternating paths. The augmenting path is a path that starts at an unmatched x-node and ends in an unmatched y-node. As both the first and last node of the augmenting path are unmatched, the path starts and ends with an edge not in the matching. When traversing the path from the x node to the y-node, every y-node in the path is matched, except for the last, and the edge following it is the one in M that connects the y-node to its matched x-node. Hence the x-node following any y-node in an augmenting path is uniquely determined and given by the matching. In turn every x-node in the path is matched, except for the first one, which was added by the y-node it is matched to. However, the edge following the x-node in an augmenting path may be one of multiple edges in the equality graph as it is not an edge contained in the matching.

The augmenting path has one more edge that is not contained in the matching than edges in M. One can construct another matching M′ by removing all the edges in the augmenting path that are in M and adding to it the edges in the path that are not in M. This will increase the number of edges by 1, i.e., |M′|=|M|+1. Additionally, M′ is also a matching. This can be seen as follows: each y that was previously matched will be connected to the x that came before it in the path rather than the one that follows it. Each x that was matched to the y-node preceding it will now be matched to the y trailing it. Each node that was adjacent to M is removed once from M and added once to M′ so each node is present in at most one edge in M′.

Another alternating path can be a pivot path. The pivot path starts at a y-node and connects to the x it is matched to. It is also exhaustive, meaning that the path ends when it cannot be extended anymore which is either an unmatched y, all the nodes have been visited or x is not connected to any other y nodes than its match.

The alternating tree starting at a node v can represent all alternating paths that can be constructed or traversed originating from v. For example, the alternating tree originating at x₀ can represent all alternating paths constructed or traversed originating from x₀ in the equality graph 300. Focusing on unmatched x nodes (e.g., the plurality of first nodes), the alternating tree can be constructed starting from unmatched node xᵤ∈X and denote all paths by all paths starting at xᵤ=paths(xᵤ). Starting at xᵤ, all paths can be related to those starting at the y nodes (e.g., the plurality of second nodes) it is connected to through the equality graph (e.g., the equality graph 300) seen in

$$paths ( {x}_{u} ) = ⋃ \{ ( ( {x}_{u} , y ) , paths ( y ) ) \vert ( {x}_{u} , y ) ∈ {E}_{l} \} . \qquad ( 7 )$$

The alternating tree can thus be seen as the union of all pivot paths starting at the y's such that (xᵤ,y)∈Eₗ. Starting from any y node, x nodes are added by y nodes that are matched, xᵤ does not need to be revisited again. Either y is unmatched where no path carries on from the node and the paths are identified or y is matched, in which case the set of all paths can be written as

$$paths ( y ) = \{ ( ( x , y ) , paths ( x \vert excluding y visited ) ) \vert x = match ( y ) \} . \qquad ( 8 )$$

To avoid creating cycles, y nodes visited are recorded. This is not as important for x nodes because they are added by the y nodes they are matched to and can thus only be added by one y node. If y nodes are not duplicated that will ensure that x nodes are not duplicated either. Similar to Equation 7 but now with the history of previously visited y nodes Yₚ∈Y,

$$paths ( x , {Y}_{p} ) = ⋃ \{ ( ( x , y ) , paths ( y ) ) \vert ( x , y ) ∈ {E}_{l} ∧ y ∉ {Y}_{p} \} \qquad ( 9 )$$

The alternating trees can thus be represented by sets S⊂X and T⊂Y of nodes that are visited when constructing all paths. S can be evaluated once T is known by S={xᵤ}∪{x|y∈TΛx=match(y)}.

While constructing the sets, the union of sets of already visited nodes will not change an outcome so previous nodes do not have to be revised. As a result, a recursive relation occurs of

$$T ( y ) = \{ y \} ⋃ \{ T ( {y}^{′} ) \vert ( x , {y}^{′} ) ∈ {E}_{l} , x = match ( y ) \} . \qquad ( 10 )$$

Thus, the alternating tree starting at node y is the union of trees of y′ nodes connected to the x-node it is matched to.

Equation 10 can be further generalized by expansion to eventually yield both the recursive and introspective relation by

$$T ( y ) = ⋃ \{ T ( {y}^{′} ) \vert {y}^{′} ∈ T ( y ) \} \qquad ( 11 )$$

which states that the alternating tree starting at y is the union of the trees T_{y′} for y′∈T_{y}-nodes it includes.

Responsive to the set representation of the alternating tree being determined, this can allow for determining whether or not to create an augmenting path (e.g., by the augmenting tree generator 116). The alternating tree, represented by T(xᵤ), is augmenting if at least one yᵤ∈T(xᵤ) is unmatched and thus is an augmenting tree. In that case there exists at least one augmenting path that connects xᵤ with yᵤ. Conversely, if there are no unmatched y node in T, then no augmenting path can be created that starts at xᵤ.

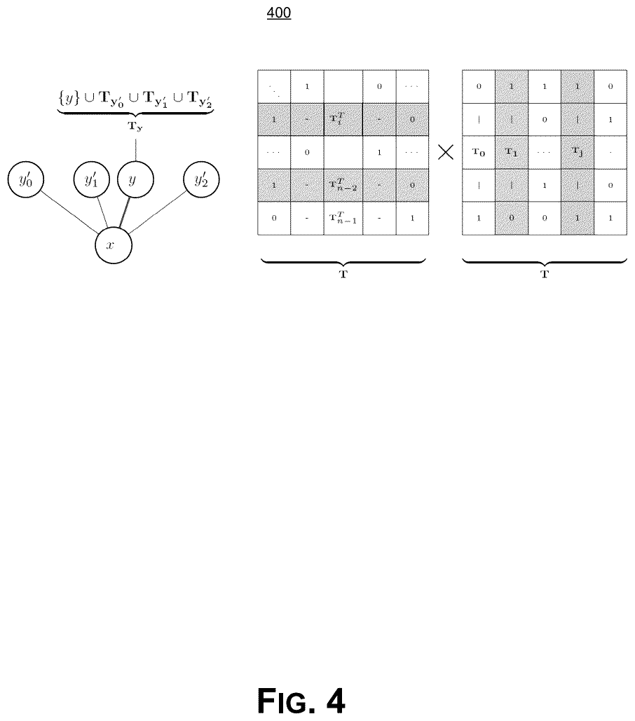

Now referring to FIG. 4, FIG. 4 depicts a diagram 400 of alternating tree initialization and bitwise matrix multiplication, in accordance with some implementations of the present disclosure. The alternating tree can be represented by the bit array. The bit array representation of the alternating tree includes one bit for every y-node that indicates whether or not it is contained in the tree with a zero or one. The alternating tree starting at pivot node y can be represented as

$${T}_{y} = [ \begin{matrix}( int ) ( {y}^{′} = 0 ∈ {T}_{7} ) \\ ( int ) ( {y}^{′} = 1 ∈ {T}_{y} ) \\ ⋮ \\ ( int ) ( {y}^{′} = k ∈ {T}_{y} ) \\ ⋮ \\ ( int ) ( {y}^{′} = N - 1 ∈ {T}_{y} )\end{matrix} ] . \qquad ( 12 )$$

All alternating trees, the tree-forest of all y-trees, can be represented by the bit matrix

$$T = [ \begin{matrix}⋮ & ⋮ & & ⋮ & & ⋮ \\ {T}_{0} & {T}_{1} & ⋯ & {T}_{k} & ⋯ & {T}_{N - 1} \\ ⋮ & ⋮ & & ⋮ & & ⋮\end{matrix} ] . \qquad ( 13 )$$

In terms of the bit array Tₙ and tree forest T for y=n tree Tₙ the introspective Equation 11 can turn into

$$\begin{matrix}{T}_{n} = σ ( {( {T}_{n} )}_{0} {T}_{0} + ⋯ + {( {T}_{n} )}_{k} + ⋯ + {( {T}_{n} )}_{N - 1} {T}_{N - 1} ) \\ = σ ( {\sum }_{k} {t}_{kn} {T}_{k} ) \\ = σ ( T ∘ {T}_{n} )\end{matrix} \qquad ( 14 )$$

with elements tₖₙ=(Tₙ)ₖ and heavy side function σ(z)=0 if z=0 and σ(z)=1 otherwise and T∘Tₙ is a matrix-vector product. Since this is true for every n∈0 . . . N−1 Equation 11 can be summarized by

$$T = σ ( T ∘ T ) \qquad ( 15 )$$

where T∘T is a matrix-matrix product which can be seen in FIG. 4.

The alternating trees of the equality graph, as shown in FIG. 4, can be iteratively computing the tree forest T in its entirety by repeating

$${T}^{n + 1} = σ ( {T}^{n} ∘ {T}^{n} ) \qquad ( 16 )$$

as suggested by Equations 11 and 15. Each alternating tree can be represented by the bit array

$${T}_{k}^{0} = \{ y = k \} ⋃ \{ {y}^{′} \vert ( x , {y}^{′} ) ∈ {E}_{l} for x = match ( y ) \} \qquad ( 17 )$$

based on Equation 10. This tree initiation process is illustrated in FIG. 4. The computation will converge to T within ² log N steps. The alternating algorithm is broken up into four parts which include tree initialization, iteration of matrix-matrix multiplication, tree transposing (e.g., create bit arrays representing the rows of trees Tⁿ), bitwise matrix-matrix multiplication via

$${T}_{ij}^{n + 1} = σ ( {( {T}^{T} )}_{i}^{n} \& {T}_{j}^{n} ) ,$$

and composing the tree result (e.g., rearrange the resulting bits). FIG. 2 depicts another example of the alternating algorithm.

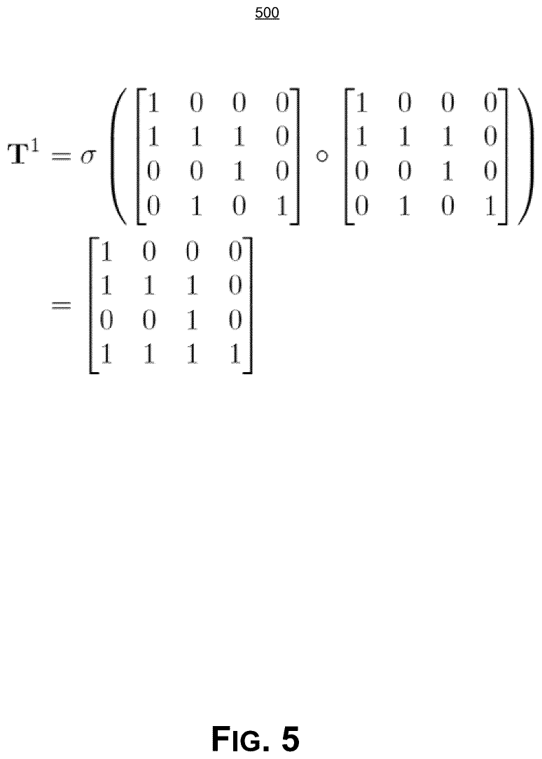

Now referring to FIG. 5, FIG. 5 depicts example equations of bitwise matrix multiplication 500 (e.g., as can be performed by the system 100), in accordance with some implementations of the present disclosure. While certain portions of the bitwise matrix multiplication may have differing computational complexity, the operations described herein can allow for more efficient overall performance of such operations by obviating the need for more complex sequences of operations, including but not limited to for techniques being applied to cost matrixes of size N=128 or less. Using FIG. 2 as an example, the alternating trees can be initialized by as y₀ is matched to x₂ the initial bit array tree of y₀ is set to the y-nodes that x₂ is connected to (e.g., y₀ and y₁) in

$${T}_{0} = [ \begin{matrix}1 \\ 1 \\ 0 \\ 0\end{matrix} ] .$$

For y₁, match(y=1)=0 and x₀ is connected to y₁ and y₃, so the bit array representing the tree starting at y₁ is

$${T}_{1} = [ \begin{matrix}0 \\ 1 \\ 0 \\ 1\end{matrix} ] .$$

Similarly, match(y=2)=1 and x₁ is connected to y₁ and y₂ so

$${T}_{2} = [ \begin{matrix}0 \\ 1 \\ 1 \\ 0\end{matrix} ] .$$

Since y₃ in unmatched, it's tree only includes itself with

$${T}_{3} = [ \begin{matrix}0 \\ 0 \\ 0 \\ 1\end{matrix} ] .$$

The initial bit matrix of trees T⁰ is thus

$${T}_{3} = [ \begin{matrix}1 & 0 & 0 & 0 \\ 1 & 1 & 1 & 0 \\ 0 & 0 & 1 & 0 \\ 0 & 1 & 0 & 1\end{matrix} ] .$$

Subsequent iterations of the alternating trees can be done by multiplying the previous matrix with itself and truncating the resulting entries as seen in FIG. 5. Once multiplying the resulting matrix does not change the result, the tree forest must be T=T¹. As the unmatched node x₃ is only connected to y₂, the alternating tree for x₃ is given by T₂:

$$T ( {x}_{3} ) = [ \begin{matrix}0 \\ 1 \\ 1 \\ 1\end{matrix} ] .$$

The tree thus contains unmatched node y₃ and an augmenting path starting from x₃ by inspecting the computed trees can be established. No paths had to be traversed to reach this conclusion.

The y trees T calculated can be used to construct the alternating trees originating from unmatched x-nodes. In addition, we know that the x-nodes include the unmatched xᵤ-node and those that are matched to the y-nodes via S={xᵤ}∪{x|x=match(y), y∈Y}. Therefore, in only the T part of the tree is needed to construct the entire tree. The alternating x-tree is the union of the y-trees it's directly connected to

$${T}_{{x}_{u}} = ⋃ \{ {T}_{y} \vert ( x , y ) ∈ {E}_{l} \} \qquad ( 18 )$$

The xᵤ tree is considered augmenting if there is an unmatched y-node in Tₓ_{ᵤ}. There exists an augmenting path starting from an unmatched xᵤ if and only if the alternating tree Tₓ_{ᵤ} is an augmenting tree.

In some implementations, path augmentation can be done in parallel. To check that that the augmenting trees are disjunct for any pair of unmatched x-nodes, Tₓ_{ᵤ}& Tₓ_{_{u′}}=0 using the bitwise & operator. The S-sets of the trees are disjunct if their T-sets are: Tₓ_{ᵤ}∩Tₓ_{_{u′}}=0⇒Sₓ_{ᵤ}∩Sₓ_{_{u′}}=Ø.

Tₓ_{ᵤ} can be referred to as the xᵤ tree. To determine that trees xₐ_{ᵢ} and xₐ_{ⱼ} are overlapping, there can be nₐ augmenting trees indicated by their starting xᵤ node index. The trees can then be sorted and labelled incrementally so that nodes xₐ_{ᵢ} have indices u=aᵢ for i∈{0 . . . nₐ−1}. The nₐ×nₐ bit-matrix can then be constructed as

$$( {M}_{no} ) = \sim {T}_{{x}_{{a}_{i}}} \& {T}_{{x}_{{a}_{j}}} . \qquad ( 19 )$$

Next, the subset of mutually non-overlapping trees, as determined by Equation 19, can be iteratively added to the xᵤ tree to the subset that is not overlapping with other trees thus far and which has the most number of 1s in its corresponding row of the Mₙₒ-matrix. This subset would be ideally maximized.

After finding the subset of non-overlapping trees, alternating paths constructed from various xₐ_{ₖ} will not overlap. One array of length N to mark the x-nodes and one array of the same length to mark the y-nodes can thus be defined. The arrays N can store a shortest distance to an unmatched x node. The thread with thread-x index equal to the corresponding unmatched node index threadIdx.x=x₂ can mark all neighbors (e.g.,) y-nodes connected through the equality graph, as having distance 1). At each iteration, the nodes that are at the front of the search, for which distance=iteration, will mark all its unmarked neighbors with their distance to the unmatched node. Two variables can be updated when a y-node is added. One can be yₚᵣₑᵥ where y′=yₚᵣₑᵥ-node preceded it and the matched yₚᵣₑᵥ of the x-node that marked y. The other can be a path which can be a bit array that indicates which y nodes are included in the path so far. If the path connects an unmatched yᵤ, it is marked and the path search will not continue from there. If nₐ number of unmatched yᵤ nodes have been marked, the algorithm stops. Path augmentation can thus be executed by variables yₚᵣₑᵥ and path.

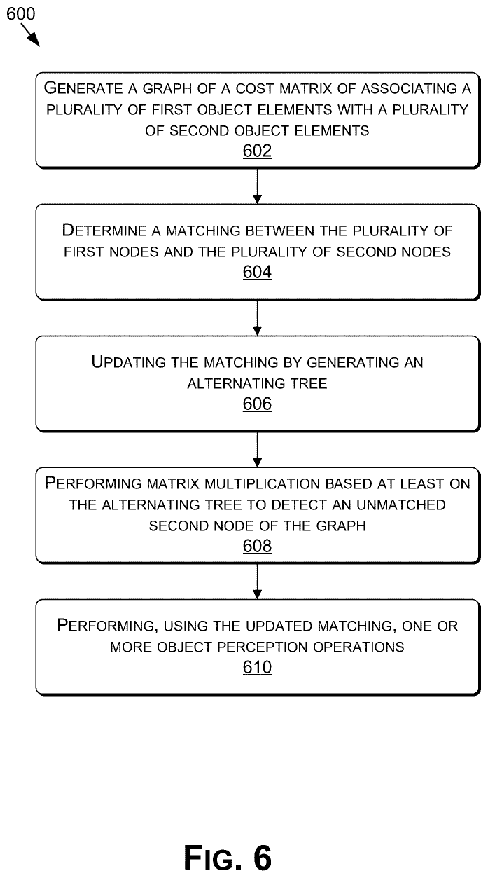

Now referring to FIG. 6, each block of method 600, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 600 is described, by way of example, with respect to the blah blah system of FIG. 1. However, these methods may additionally or alternatively be executed by any one system, or any combination of systems, including, but not limited to, those described herein.

FIG. 6 is a flow diagram showing a method 600 for object detection on parallel processing systems, in accordance with some implementations of the present disclosure. The method 600, at block 602, includes generating a graph of a cost matrix of associating a plurality of first object elements with a plurality of second object elements. The plurality of first object elements can be test bounding boxes and the plurality of second object elements can be reference bounding boxes. The graph generator 108 can, for example, generate the graph of the cost matrix at block 602. The graph can include a plurality of first nodes representing rows of the cost matrix and a plurality of second nodes representing columns of the cost matrix. The graph can be an equality graph and/or a bipartite graph.

The method 600, at block 604, includes determining a matching between the plurality of first nodes and the plurality of second nodes based at least on the cost matrix. The matching can be performed by the matcher 110. The matching can also be initially based on the first of the plurality of second nodes that each of the plurality of first nodes finds.

The method 600, at block 606, includes updating the matching by generating, based at least on the matching, an alternating tree that represents a path from a given second node along one or more edges connected with the given second node. For example, the matching can be updated by the alternating tree starting at an unmatched second node. Each of the plurality of second nodes can correspond to a plurality of alternating trees.

The method 600, at block 608, includes performing one or more matrix multiplications based at least on the alternating tree to detect an unmatched second node of the graph for which to update the matching. For example, to determine which of the plurality of second nodes of the graph are unmatched, perform matrix multiplication of the bit array representing the plurality of alternating trees of the graph can be performed, e.g., until the resulting matrix does not change.

The method 600, at block 610, includes using the augmenting trees and/or augmenting paths to improve the labeling. For example, the augmenting trees can be used to identify unmatched and/or unconnected nodes, for which edges and/or matches can be assigned to allow for further augmentation.

The method 600, at block 612, includes performing, using the updated matching, one or more object perception operations for at least a subset of object elements from one or more of the plurality of first object elements or the plurality of second object elements. For example, to determine and identify an object, object perception operations can be performed.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed implementations may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

### Example Autonomous Vehicle

FIG. 7 is an illustration of an example autonomous vehicle 700, in accordance with some implementations of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 5 of the autonomous driving levels. The vehicle 700 may be capable of functionality in accordance with one or more of Level 1-Level 5 of the autonomous driving levels. For example, the vehicle 700 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation. The vehicle 700 can include an object detector (e.g., machine learning model-based object detector), which can use the system 100 for training and/or object detection and/or tracking operations.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to enable the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 5) functionality.

The brake sensor system 746 may be used to operate the vehicle brakes in response to receiving signals from the brake actuators 748 and/or brake sensors.

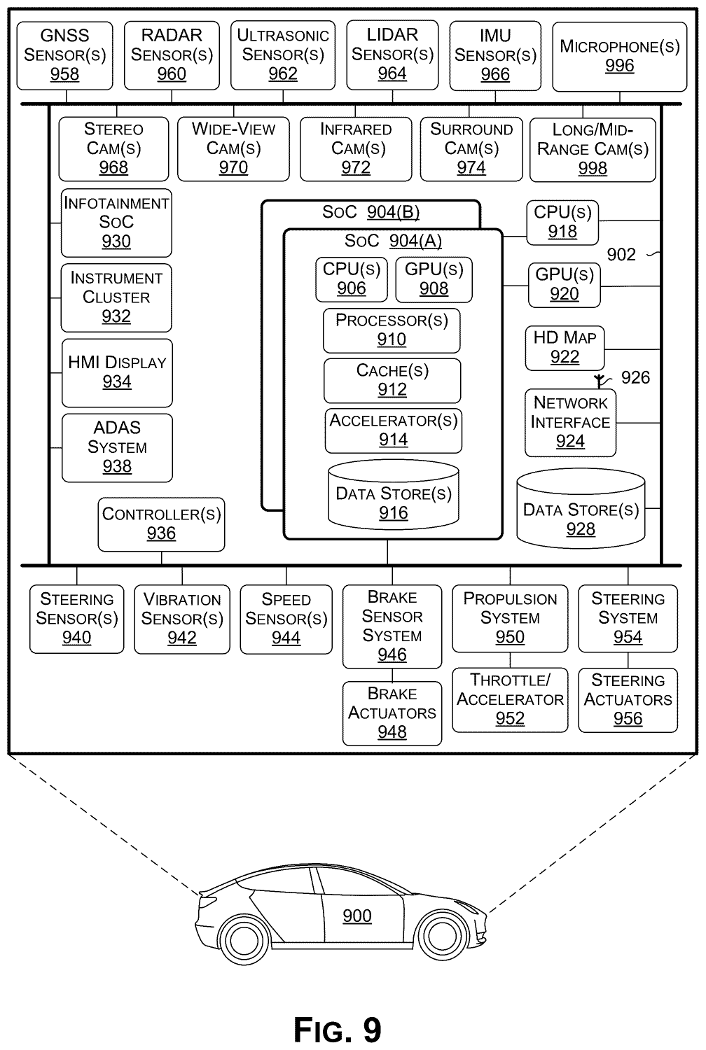

Controller(s) 736, which may include one or more system on chips (SoCs) 704 (FIG. 9) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to enable autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LIDAR sensor(s) 764, inertial measurement unit (IMU) sensor(s) 766 (e.g., accelerometer(s), gyroscope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), and/or other sensor types. Data from any of various such sensors can be used by the system 100.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the High Definition (“HD”) map 722 of FIG. 9), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

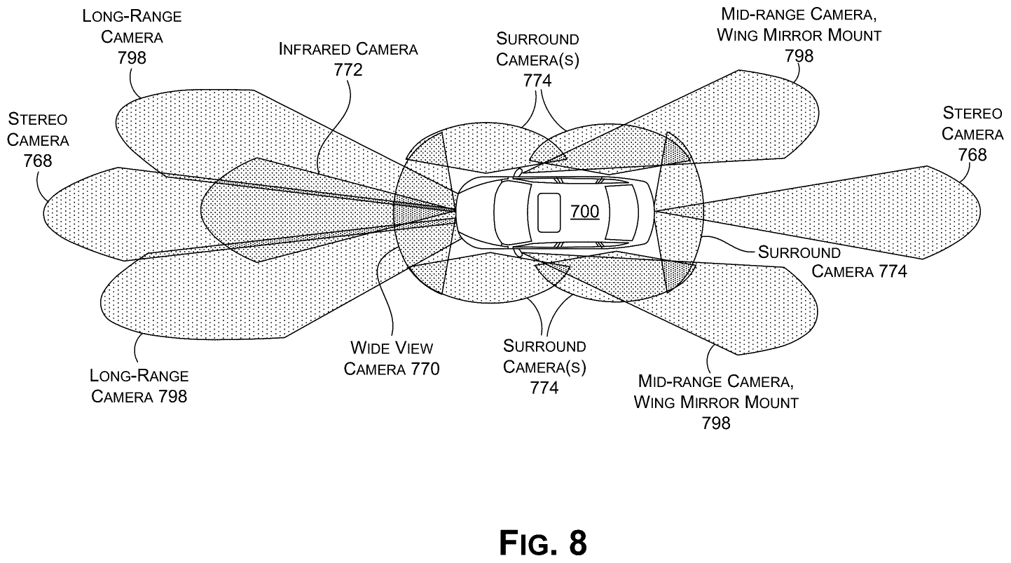

FIG. 8 is an example of camera locations and fields of view for the example autonomous vehicle 700 of FIG. 7, in accordance with some implementations of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some implementations, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 770 that may be used to perceive objects coming into view from the periphery (e.g., pedestrians, crossing traffic or bicycles). Although only one wide-view camera is illustrated in FIG. 8, there may be any number (including zero) of wide-view cameras 770 on the vehicle 700. In addition, any number of long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

Any number of stereo cameras 768 may also be included in a front-facing configuration. In at least one embodiment, one or more of stereo camera(s) 768 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 8) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

FIG. 9 is a block diagram of an example system architecture for the example autonomous vehicle 700 of FIG. 7, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 9 are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

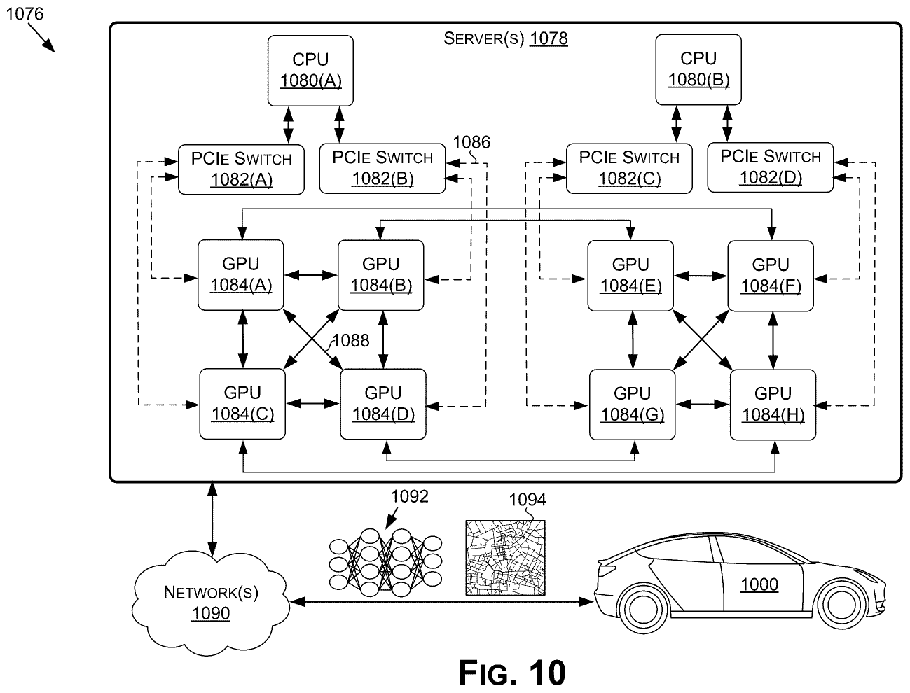

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 10).

The CPU(s) 706 may include a CPU cluster or CPU complex (alternatively referred to herein as a “CCPLEX”). The CPU(s) 706 may include multiple cores and/or L2 caches. For example, in some implementations, the CPU(s) 706 may include eight cores in a coherent multi-processor configuration. In some implementations, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation enabling any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some implementations, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between processing threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some implementations, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some implementations, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LIDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 712 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to enable communication with peripherals, audio codecs, power management, and/or other devices. The SoC(s) 704 may be used to process data from cameras (e.g., connected over Gigabit Multimedia Serial Link and Ethernet), sensors (e.g., LIDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760 m (front) or 80 m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B.

The vehicle 700 may include LIDAR sensor(s) 764. The LIDAR sensor(s) 764 may be used for object and pedestrian detection, emergency braking, collision avoidance, and/or other functions. The LIDAR sensor(s) 764 may be functional safety level ASIL B. In some examples, the vehicle 700 may include multiple LIDAR sensors 764 (e.g., two, four, six, etc.) that may use Ethernet (e.g., to provide data to a Gigabit Ethernet switch).

In some examples, the LIDAR sensor(s) 764 may be capable of providing a list of objects and their distances for a 360-degree field of view. Commercially available LIDAR sensor(s) 764 may have an advertised range of approximately 700 m, with an accuracy of 2 cm-3 cm, and with support for a 700 Mbps Ethernet connection, for example. In some examples, one or more non-protruding LIDAR sensors 764 may be used. In such examples, the LIDAR sensor(s) 764 may be implemented as a small device that may be embedded into the front, rear, sides, and/or corners of the vehicle 700. The LIDAR sensor(s) 764, in such examples, may provide up to a 120-degree horizontal and 35-degree vertical field-of-view, with a 200 m range even for low-reflectivity objects. Front-mounted LIDAR sensor(s) 764 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 700. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some implementations, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the implementations and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7 and FIG. 8.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include a SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LIDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 700), while the I2V communication concept provides information about traffic further ahead. CACC systems may include either or both I2V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some implementations, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In implementations that include a neural network(s) running on the supervisory MCU, the supervisory MCU may include at least one of a DLA or GPU suitable for running the neural network(s) with associated memory. In preferred implementations, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 10 is a system diagram for communication between cloud-based server(s) and the example autonomous vehicle 700 of FIG. 7, in accordance with some implementations of the present disclosure. The system 776 may include server(s) 778, network(s) 790, and vehicles, including the vehicle 700. The server(s) 778 may include a plurality of GPUs 784(A)-784(H) (collectively referred to herein as GPUs 784), PCIe switches 782(A)-782(H) (collectively referred to herein as PCIe switches 782), and/or CPUs 780(A)-780(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some implementations of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some implementations, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein, including, for example, for executing operations of the system 100 and/or to perform object detection and/or matching operations. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In implementations, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In implementations, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In implementations, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like. Various such components can be used to implement the processing threads described with reference to FIG. 1.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one implementations of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 1216(1)-1216(N) may correspond to a server having one or more of the above-mentioned computing resources. In addition, in some implementations, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein, such as for training object detector or computer vision models.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
generate a graph of a cost matrix associating a plurality of first object elements with a plurality of second object elements, the graph comprising a plurality of first nodes representing rows of the cost matrix and a plurality of second nodes representing columns of the cost matrix;
determine a matching between the plurality of first nodes and the plurality of second nodes based at least on the cost matrix;
update the matching by generating, based at least on the matching, an alternating tree that represents a path from a given second node along one or more edges connected with the given second node, and performing one or more matrix multiplications based at least on the alternating tree to detect an unmatched second node of the graph for which to update the matching; and
perform, using the updated matching, one or more object perception operations for at least a subset of object elements from one or more of the plurality of first object elements or the plurality of second object elements.

2. The one or more processors of claim 1, wherein the one or more circuits are to determine the matching by:
identifying, by each first node and using a respective processing thread of a plurality of processing threads, a second node of the plurality of second nodes with which the first node is connected; and
selecting, by each second node, the first node that identified the second node.

3. The one or more processors of claim 1, wherein the one or more circuits are to:
generate a first bit array to represent the alternating tree; and
perform the one or more matrix multiplications, using a plurality of processing threads, as one or more bitwise matrix multiplications of a matrix comprising the first bit array and a plurality of second bit arrays.

4. The one or more processors of claim 1, wherein the plurality of first object elements comprise estimated bounding boxes generated by an object detector, the plurality of second object elements comprise reference bounding boxes, and the one more circuits are to update the object detector based at least on the updated matching.

5. The one or more processors of claim 1, wherein the plurality of first object elements correspond to data from a sensor of a vehicle.

6. The one or more processors of claim 1, wherein the one or more circuits are to update the matching by adding a match between the unmatched second node and a first node corresponding to the unmatched second node to the matching.

7. The one or more processors of claim 1, wherein the one or more circuits are to determine the matching based on identifying respective matches between the plurality of first nodes and plurality of second nodes that satisfy a feasibility criterion.

8. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system comprising one or more large language models (LLMs);
a system comprising one or more vision language models (VLMs);
a system for generating synthetic data;
a system incorporating one or more virtual machines (VMs);
a system implemented at least partially in a data center; or
a system implemented at least partially using cloud computing resources.

9. A system comprising:
one or more processing units; and
one or more memory units storing instructions that, when executed by the one or more processing units, cause the one or more processing units to execute operations comprising:
generating a graph of a cost matrix associating a plurality of first object elements with a plurality of second object elements, the graph comprising a plurality of first nodes representing rows of the cost matrix and a plurality of second nodes representing columns of the cost matrix;
determining a matching between the plurality of first nodes and the plurality of second nodes based at least on the cost matrix;
updating the matching by generating, based at least on the matching, an alternating tree that represents a path from a given second node along one or more edges connected with the given second node, and performing one or more matrix multiplications based at least on the alternating tree to detect an unmatched second node of the graph for which to update the matching; and
performing, using the updated matching, one or more object perception operations for at least a subset of object elements from one or more of the plurality of first object elements or the plurality of second object elements.

10. The system of claim 9, wherein the one or more processing units are to determine the matching by:
identifying, by each first node and using a respective processing thread of a plurality of processing threads, a second node of the plurality of second nodes with which the first node is connected; and
selecting, by each second node, the first node that identified the second node.

11. The system of claim 9, wherein the one or more processing units are to:
generate a first bit array to represent the alternating tree; and
perform the one or more matrix multiplications, using a plurality of processing threads, as one or more bitwise matrix multiplications of a matrix comprising the first bit array and a plurality of second bit arrays.

12. The system of claim 9, wherein the plurality of first object elements comprise estimated bounding boxes generated by an object detector, the plurality of second object elements comprise reference bounding boxes, and the one more processing units are to update the object detector based at least on the updated matching.

13. The system of claim 9, wherein the plurality of first object elements correspond to data from a sensor of a vehicle.

14. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for generating or presenting at least one of augmented reality content, virtual reality content, or mixed reality content;
a system for hosting one or more real-time streaming applications;
a system implemented using an edge device;
a system implemented using a robot;
a system for performing conversational AI operations;
a system comprising one or more large language models (LLMs);
a system comprising one or more vision language models (VLMs);
a system for generating synthetic data;
a system incorporating one or more virtual machines (VMs);
a system implemented at least partially in a data center; or
a system implemented at least partially using cloud computing resources.

15. A method comprising:
generating a graph of a cost matrix associating a plurality of first object elements with a plurality of second object elements, the graph comprising a plurality of first nodes representing rows of the cost matrix and a plurality of second nodes representing columns of the cost matrix;
determining a matching between the plurality of first nodes and the plurality of second nodes based at least on the cost matrix;
updating the matching by generating, based at least on the matching, an alternating tree that represents a path from a given second node along one or more edges connected with the given second node, and performing one or more matrix multiplications based at least on the alternating tree to detect an unmatched second node of the graph for which to update the matching; and
performing, using the updated matching, one or more object perception operations for at least a subset of object elements from one or more of the plurality of first object elements or the plurality of second object elements.

16. The method of claim 15, further comprising:
identifying, by each first node and using a respective processing thread of a plurality of processing threads, a second node of the plurality of second nodes with which the first node is connected; and
selecting, by each second node, the first node that identified the second node.

17. The method of claim 15, further comprising:
generating a first bit array to represent the alternating tree; and
performing the one or more matrix multiplications, using a plurality of processing threads, as one or more bitwise matrix multiplications of a matrix comprising the first bit array and a plurality of second bit arrays.

18. The method of claim 15, wherein the plurality of first object elements comprise estimated bounding boxes generated by an object detector, the plurality of second object elements comprise reference bounding boxes, and method comprises updating the object detector based at least on the updated matching.

19. The method of claim 15, wherein the plurality of first object elements correspond to data from a sensor of a vehicle.

20. The method of claim 15, further comprising updating, by the one or more processors, the matching by adding a match between the unmatched second node and a first node corresponding to the unmatched second node to the matching.
